(19) United States
(12) Patent Application Publication
(10) Pub. No.: US 2026/0329084 A1
(43) Pub. Date: Oct. 22, 2026

(54) AUTOMOTIVE DISPLAY

(71) Applicant: AUO Corporation, Hsinchu City (TW)

(72) Inventors: Yu-Chun HUANG, Hsinchu City (TW); Jien-Feng HUANG, Hsinchu City (TW); Yu-Hsieh LIU, Hsinchu City (TW); Sheng-Yuan WANG, Hsinchu City (TW); Cheng-Chih HSIEH, Hsinchu City (TW); Han-Yueh YANG, Hsinchu City (TW)

(21) Appl. No.: 19/419,495

(22) Filed: Dec. 15, 2025

(30) Foreign Application Priority Data
Apr. 21, 2025 (TW) 114114965

(51) Int. Cl. G02B 27/01

(52) U.S. Cl. CPC G02B 27/0149; G02B 2027/0169

(57) ABSTRACT

A display is disclosed, including a display panel, a first transparent cover plate, a second transparent cover plate and a connecting base. The display panel has a first surface including a first end and a second surface including a second end. The first transparent cover plate is connected to the first surface and has a first protruding portion configured to protrude out of the first end and having a first assembly hole. The second transparent cover plate is connected to the second surface and has a second protruding portion configured to protrude out of the second end and having a second assembly hole. The connecting base includes a first frame having a first positioning mechanism and a second frame having a second positioning mechanism. The first and second positioning mechanisms respectively correspond to the first assembly hole, and the first and second frames are connected via the first assembly hole.

### CROSS-REFERENCE TO RELATED PATENT APPLICATION

This non-provisional application claims priority to and the benefit of, pursuant to 35 U.S.C. § 119(a), patent application Serial No. 114114965 filed in Taiwan on Apr. 21, 2025. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present disclosure relates to relates to a display, and particularly to an automotive display placed in front of a driver.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Currently, in-vehicle displays generally extend from the instrument panel to the central information display (CID) and are not transparent displays, which is less convenient for drivers. With the evolution of display technology, transparent display technologies have matured, and using transparent displays in vehicles to provide information to drivers and passengers has become a technical solution worth considering. Due to the characteristics of the transparent display, its purpose is typically to allow the scenery behind the display to remain visible to the driver or passengers. If a traditional display bezel design is used, the bezel often obstructs the line of sight, thus making the bezel design more challenging.

### SUMMARY

To resolve the above technical problems, one embodiment of the present disclosure provides a display including a display panel, a first transparent cover plate, a second transparent cover plate and a connecting base. The display panel has a first surface including a first end and a second surface including a second end, where the first surface corresponds to the second surface, and the first end corresponds to the second end. The first transparent cover plate is connected to the first surface and has a first protruding portion configured to protrude out of the first end, and the first protruding portion has at least one first assembly hole. The second transparent cover plate is connected to the second surface and has a second protruding portion configured to protrude out of the second end. The connecting base includes a first frame and a second frame. The first frame is disposed at one side of the first protruding portion and has at least one first positioning mechanism. The second frame is disposed at another side of the first protruding portion relative to the first frame and has at least one second positioning mechanism, where the at least one first positioning mechanism is connected to the at least one second positioning mechanism via one of the at least one first assembly hole.

Another embodiment of the present disclosure provides an automobile display including a display panel, a first transparent cover plate, a second transparent cover plate and a connecting base. The display panel has a first surface including a first end and a second surface including a second end, where the first surface corresponds to the second surface, and the first end corresponds to the second end. The first transparent cover plate is connected to the first surface and has a first protruding portion configured to protrude out of the first end, and the first protruding portion has at least one first assembly hole. The second transparent cover plate is connected to the second surface and has a second protruding portion configured to protrude out of the second end. The connecting base includes a first frame and a second frame. The first frame is disposed at one side of the first protruding portion and has at least one first positioning mechanism. The second frame is disposed at another side of the first protruding portion relative to the first frame and has at least one second positioning mechanism, where the at least one first positioning mechanism is connected to the at least one second positioning mechanism via one of the at least one first assembly hole.

Compared with conventional technology, the embodiments of the present disclosure at least employ the first positioning mechanism of the first frame of the connecting base, the second positioning mechanism of the second frame of the connecting base and the first assembly hole of the first transparent cover plate to design a fixing method of the display that clamps and fixes the display at fewer sides or only one side, while still maintaining stability of the structural configuration of the display.

These and other aspects of the present disclosure will become apparent from the following description of the embodiment taken in conjunction with the following drawings, detailed description and the claims.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is an exploded view of a display according to a first embodiment of the present disclosure.

FIG. 2 is a perspective schematic view of the display according to the first embodiment of the present disclosure after being assembled.

FIG. 3 is a partially enlarged perspective view of the display according to the first embodiment of the present disclosure after being assembled.

FIG. 4 is a schematic layout view of the first assembly holes according to the first embodiment of the present disclosure.

FIG. 5 is an exploded view of a display according to a second embodiment of the present disclosure.

FIG. 6 is a partially enlarged perspective view of the display according to the second embodiment of the present disclosure after being assembled.

FIG. 7 is a schematic view of the display being applied to a vehicle body according to certain embodiments of the present disclosure.

### DETAILED DESCRIPTION

The following will describe various embodiments, which those skilled in the relevant field, when referring to the descriptions along with the accompanying drawings, should easily understand the spirit and principles of the present disclosure. Components or portions depicted in the drawings herein may be exaggerated or modified for clarity. Thus, those skilled in the relevant field should understand that the sizes and relative proportions of the components or portions depicted in the drawings are not the actual sizes and proportions of the components or portions. In addition, although specific embodiments are provided in detail, these embodiments are intended for illustrative purposes only and should not be considered restrictive or exhaustive in any aspect. Accordingly, for those skilled in the art, various modifications and alterations of the present disclosure should be evident and easily achievable without departing from its spirit and principles.

It should be understood that terms such as “first”, “second”, and “third” are used to describe various elements, components, regions, layers and/or portions herein. However, these elements, components, regions, layers and/or parts should not be limited by these terms. These words are only used for distinguishing between an element, a component, a region, a layer and/or a part from another element, component, region, layer and/or portion. Therefore, a first “element”, “component”, “region”, “layer” and/or “portion” hereinafter may also be referred to as a second “element”, “component”, “region”, “layer” and/or “portion” without departing from the concept of the present disclosure.

In addition, conventional elements in the embodiments of the present disclosure may not be described in detail or may be omitted to avoid obscuring relevant details. In the following descriptions, the drawings and description provide specific details for explanatory, non-limiting purposes to facilitate a thorough understanding of the embodiments of the present disclosure. However, it should be apparent that the disclosure can be practiced without these specific details.

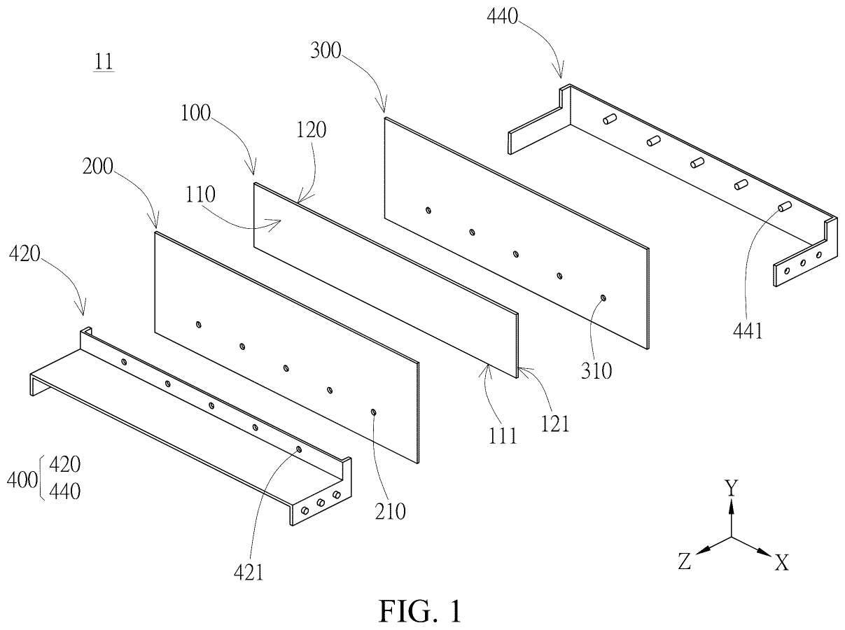

Referring to FIG. 1, which is an exploded view of a display according to a first embodiment of the present disclosure. In the first embodiment, the display 11 includes a display panel 100, a first transparent cover plate 200, a second transparent cover plate 300 and a connecting base 400. A portion of the display panel 100 adjacent to the first transparent cover plate 200 may be referred to as the first surface 110, and a portion of the display panel 100 adjacent to the second transparent cover plate 300 may be referred to as the second surface 120, where the first surface 110 corresponds to the second surface 120. A bottom of the first surface 110 may be referred to as the first end 111, and a bottom of the second surface 120 may be referred to as the second end 121, where the first end 111 corresponds to the second end 121.

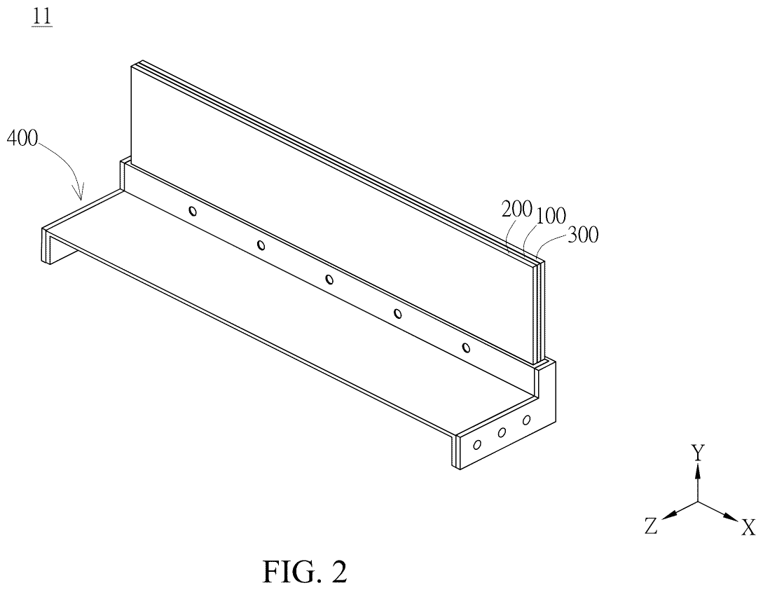

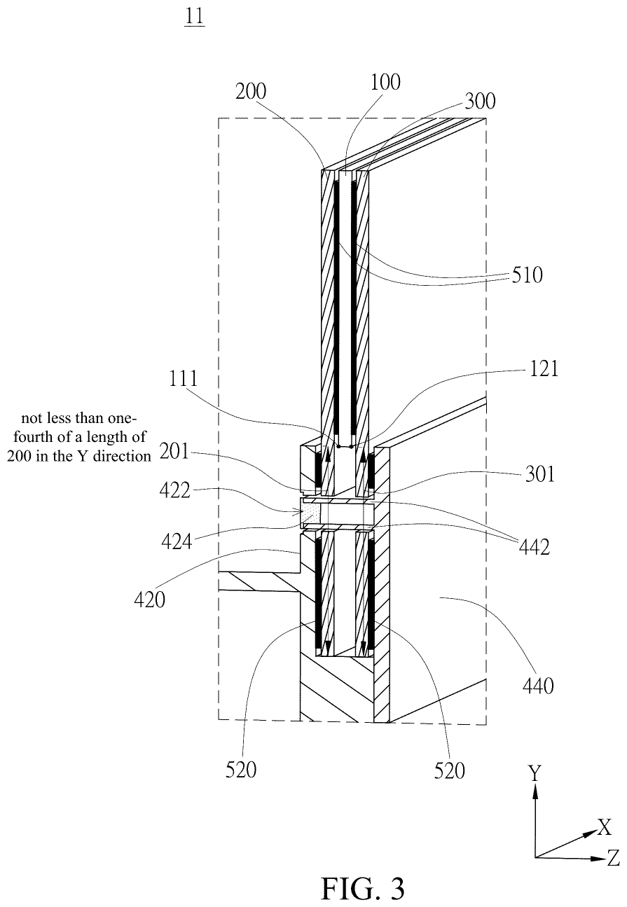

As shown in FIG. 1, the first transparent cover plate 200 has at least one first assembly hole 210, e.g., a plurality first assembly holes 210 arranged along a direction parallel to the X-axis in FIG. 1. The second transparent cover plate 300 has at least one second assembly hole 310, e.g., a plurality of second assembly holes 310 arranged along the direction parallel to the X-axis in FIG. 1. The connecting base 400 includes a first frame 420 and a second frame 440. The first frame 420 has at least one first positioning mechanism 421, e.g., a plurality of first positioning mechanisms 421 arranged along the direction parallel to the X-axis in FIG. 1. The second frame 440 has at least one second positioning mechanism 441, e.g., a plurality of second positioning mechanisms 441 arranged along the direction parallel to the X-axis in FIG. 1. Descriptions of the display after being assembled are described with reference to FIGS. 2 and 3 as follows.

Referring to FIGS. 2 and 3, where FIG. 2 is a perspective schematic view of the display according to the first embodiment of the present disclosure after being assembled, and FIG. 3 is a partially enlarged perspective view of the display according to the first embodiment of the present disclosure after being assembled. As shown in FIG. 2, in the display 11 after being assembled, the first transparent cover plate 200 is connected to the first surface 110 of the display panel 100, and the second transparent cover plate 300 is connected to the second surface 120 of the display panel 100. Further, the at least one first positioning mechanism 421 of the first frame 420 and the at least one second positioning mechanism 441 of the second frame 440 respectively correspond to first assembly holes 210 of the first transparent cover plate 200. The relative positions of the elements of the display 11 after being assembled are further described with reference to FIG. 3.

As shown in FIG. 3, in the display 11 after being assembled, the first transparent cover plate 200 has a first protruding portion 201 configured to protrude out of the first end 111 of the first surface 110 of the display panel 100, and the first protruding portion 201 has the aforementioned first assembly holes 210. In the display 11 after being assembled, the second transparent cover plate 300 has a second protruding portion 301 configured to protrude out of the second end 121 of the second surface 120 of the display panel 100, and the second protruding portion 301 has the aforementioned second assembly holes 310.

In the first embodiment, the display panel 100 of the display 11 may be implemented as a transparent display panel, such as a transparent display panel implemented with micro light-emitting diodes (Micro LED). In FIG. 2, the first frame 420 and the second frame 440 are connected to each other via the at least one first positioning mechanism 421 of the first frame 420, the first assembly holes 210 on the first protruding portion 201 of the first transparent cover plate 200, the second assembly holes 310 on the second protruding portion 301 of the second transparent cover plate 300 and the at least one second positioning mechanism 441 of the second frame 440.

In the first embodiment, the at least one first positioning mechanism 421 of the first frame 420 and the at least one second positioning mechanism 441 of the second frame 440 may be respectively implemented as at least one positioning hole 422 and at least one positioning pin 442. For example, the at least one first positioning mechanism 421 of the first frame 420 may be implemented as at least one positioning hole 422, and the at least one second positioning mechanism 441 of the second frame 440 may be implemented as at least one positioning pin 442. As shown in FIG. 3, each positioning pin 442 of the second frame 440 passes through a corresponding second assembly hole 310 of the second transparent cover plate 300 and a corresponding first assembly hole 210 of the first transparent cover plate 200 and extends into a corresponding positioning hole 422 of the first frame 420.

Thus, the clamping location of the display panel 100 can be controlled via the positions of the second assembly holes 310 of the second transparent cover plate 300, the positions of the positioning holes 422 of the first frame 420 and the positions of the positioning pins 442 of the second frame 440.

Further, the at least one first positioning mechanism 421 of the first frame 420 may be implemented to include a first fastening member 424 corresponding to the positioning hole 422, and the first fastening member 424 is fastened to an end of the positioning pin 442 of the second frame 440 extending to the positioning hole 422 via the positioning hole 422 of the first frame 420. For example, the first fastening member 424 may be implemented as a screw, and the positioning pin 442 of the second frame 440 may be implemented to have as a threaded hole structure corresponding to the screw, so as to fix the first frame 420 and the second frame 440. As described above, the display 11 of the embodiments of the present disclosure may use the first frame 420 and the second frame 440 of the connecting base 400 to clamp the bottom side of the transparent display panel along a direction parallel to the Z-axis in FIG. 2, thereby controlling the position of the transparent display panel along a direction parallel to the Y-axis.

In the embodiment of FIG. 3, the first transparent cover plate 200 and the first frame 420 at least partially overlap along the direction parallel to the Z-axis, and a length of the overlapping region along the direction parallel to the Y-axis is not less than one-fourth of a length of the first transparent cover plate 200 along the direction parallel to the Y-axis. In other words, the first transparent cover plate 200 overlaps with the first frame 420 in a direction perpendicular to the first transparent cover plate 200 (Z-axis), and the length of the overlapping region in the direction parallel to the direction of the first protruding portion 201 of the first transparent cover plate 200 protruding out of the first end 111 of the first surface 110 (Y-axis) is not less than one-fourth of the length of the first transparent cover plate 200 in the same direction (Y-axis). The aforementioned configuration considers clamping stability of the display panel 100 and maximizes the area available for display simultaneously.

In this embodiment, the first fastening member 424 is disposed at one side of the first transparent cover plate 200, so the first transparent cover plate 200 may be subjected to greater stress. To prevent fracture of the first transparent cover plate 200, it is preferable that the Young's modulus of the first transparent cover plate 200 is greater than the Young's modulus of the second transparent cover plate 300. In the first embodiment, the first transparent cover plate 200 may be implemented as a glass cover plate, and the second transparent cover plate 300 may be implemented as a glass cover plate or a plastic cover plate. Further, considering the clamping force of the first frame 420 and the second frame 440 along the direction parallel to the Z-axis, the material structures of the glass and plastic cover plates require certain strength to avoid fracture. For example, the Young's modulus of the glass cover plate is preferably between 68,000 MPa and 73,000 MPa, and a thickness of the first transparent cover plate 200 along the Z-axis direction is not less than 2 millimeters.

In the first embodiment, the second transparent cover plate 300 may be implemented as a glass cover plate or a plastic cover plate. If the second transparent cover plate 300 is implemented as the plastic cover plate, the Young's modulus of the plastic cover plate is preferably between 2,200 MPa and 3,800 MPa, and a thickness of the second transparent cover plate 300 along the Z-axis direction is not less than 5 millimeters. This configuration considers that the first fastening member 424 fastens the first frame 420 and the second frame 440 from one side of the first transparent cover plate 200, and the stress on the first transparent cover plate 200 may be greater than the stress on the second transparent cover plate 300.

In the first embodiment, an optical clear adhesive (OCA) 510 may be disposed between the display panel 100 and the first transparent cover plate 200 and between the display panel 100 and the second transparent cover plate 300. In addition, compressible materials such as a pressure-sensitive adhesive (PSA) and/or rubber 520 may be disposed between the first transparent cover plate 200 and the first frame 420, and PSA and/or rubber 520 may likewise be disposed between the second transparent cover plate 300 and the second frame 440. The OCA 510 may reduce fracture caused by relative movement and impact between the display panel 100 and the first and second transparent cover plates 200, 300, thereby increasing the clamping stress on the display panel 100 along the Y-axis direction. Similarly, the PSA and/or rubber 520 disposed between the first transparent cover plate 200 and the first frame 420 and between the second transparent cover plate 300 and the second frame 440 may reduce damage caused by relative movement, compression and impact, thereby increasing the clamping stress on the display panel 100 along the Y-axis direction.

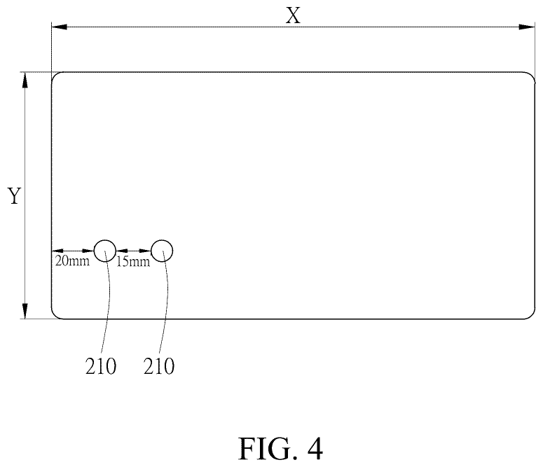

For illustrative purposes, the configuration of the at least one first assembly hole 210 of the first transparent cover plate 200 and the at least one second assembly hole 310 of the second transparent cover plate 300 are described as follows. Referring to FIG. 4, which is a schematic layout view of the first assembly holes according to the first embodiment of the present disclosure. In the first embodiment, the first assembly holes 210 of the first transparent cover plate 200 may be configured to have a distance from an edge of the first transparent cover plate 200 being not less than 20 millimeters, a diameter of each first assembly hole 210 being not less than 1.2 millimeters, and a distance between adjacent first assembly holes 210 being not less than 15 millimeters, or any combination thereof. Similarly, in the first embodiment, the configurations of the at least one second assembly hole 310 of the second transparent cover plate 300 may be the same as the configurations of the first assembly holes 210 of the first transparent cover plate 200, and are not further elaborated herein.

By way of an example and not a limiting description, in the first embodiment, the size of the positioning pin 442 may be configured to be slightly smaller than a distance between the first frame 420 and the second frame 440 along the Z-axis direction. In FIG. 3, the first frame 420 and the second frame 440 clamp, between them, the PSA and/or rubber 520 between the first frame 420 and the first transparent cover plate 200, the first transparent cover plate 200, the OCA 510 between the first transparent cover plate 200 and the display panel 100, the display panel 100, the OCA 510 between the display panel 100 and the second transparent cover plate 300, the second transparent cover plate 300, and the PSA and/or rubber 520 between the second transparent cover plate 300 and the second frame 440. This configuration considers that the OCA 510 and PSA and/or rubber 520 are compressible materials, thus configuring the size of the positioning pin 442 to be slightly smaller than the distance between the first frame 420 and the second frame 440 along the Z-axis direction, thereby preventing the positioning pin 442 from protruding from the first frame 420 and affecting clamping stress on the display panel 100 along the Y-axis direction.

To illustrate the objectives as described above, the first transparent cover plate 200, the OCA 510 between the first transparent cover plate 200 and the display panel 100, the display panel 100, the OCA 510 between the display panel 100 and the second transparent cover plate 300, and the second transparent cover plate 300 may be described as incompressible materials. Further, the PSA and/or rubber 520 between the first frame 420 and the first transparent cover plate 200 and the PSA and/or rubber 520 between the second transparent cover plate 300 and the second frame 440 may be described as compressible materials. Therefore, the size of the positioning pin 442 along the Z-axis direction may, for example, be configured to be equal to a total length of the incompressible materials in the Z-axis direction plus 95% of a total length of the compressible materials in the Z-axis direction.

In the first embodiment, the first positioning mechanisms 421 may be optionally disposed on both sides of the first frame 420 along the Z-axis direction, and the second positioning mechanisms 441 may be optionally disposed on both sides of the second frame 440 along the Z-axis direction. Further, the first frame 420 and the second frame 440 may be fixed to each other via positioning holes, positioning pins and fastening members as described above, similarly to the implementation of the positioning holes 422, positioning pins 442, and first fastening members 424 described above, and are thus not further elaborated herein.

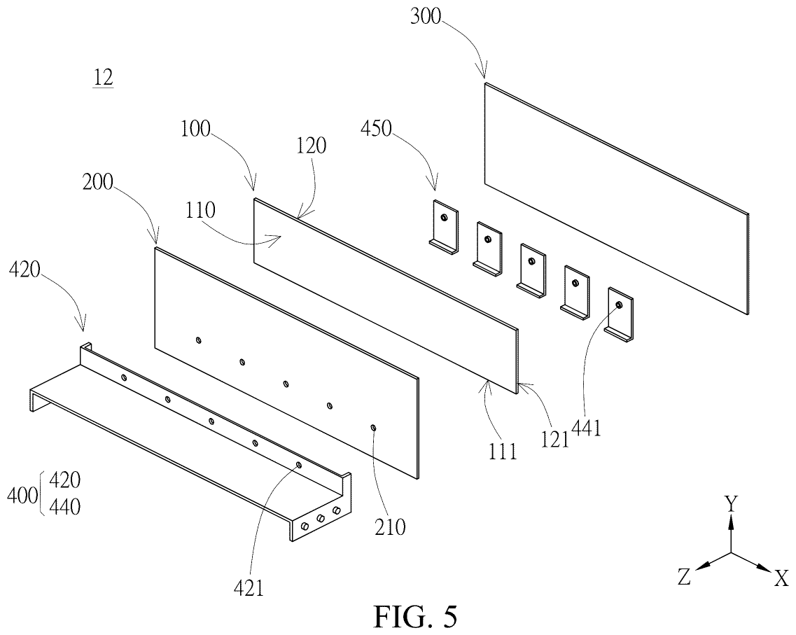

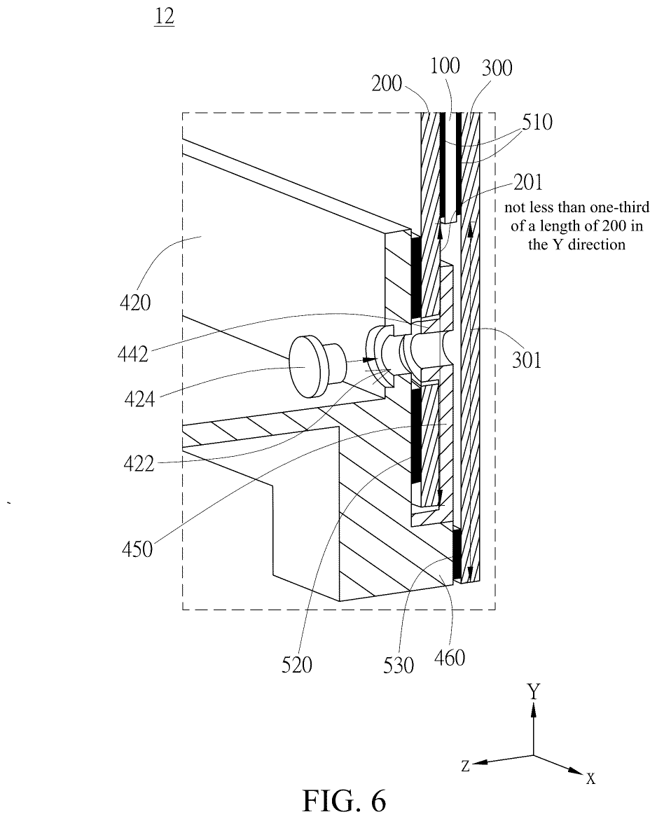

Referring to FIGS. 5 and 6, where FIG. 5 is an exploded view of a display according to a second embodiment of the present disclosure, and FIG. 6 is a partially enlarged perspective view of the display according to the second embodiment of the present disclosure after being assembled. In the second embodiment, the difference from the first embodiment exists in that the second transparent cover plate 300 does not have second assembly holes, as shown in FIG. 5.

Further, in the second embodiment, the second frames 450 are configured to correspond in quantity to the quantity of first assembly holes 210 of the first transparent cover plate 200 and are arranged at intervals, as shown in FIG. 5. The configurations of elements of the display 12 in the second embodiment after being assembled is shown in FIG. 6. In FIG. 6, the first frame 420 is disposed at one side of the first protruding portion 201 of the first transparent cover plate 200 opposite to the second protruding portion 301 of the second transparent cover plate 300. The second embodiment is different from the first embodiment in that the second frames 450 are disposed between the first protruding portion 201 of the first transparent cover plate 200 and the second protruding portion 301 of the second transparent cover plate 300, as shown in FIG. 6. In the second embodiment, the second frames 450 are configured to have a thinner thickness, such that the configuration space occupied by the entire display 12 is reduced.

Further, in the second embodiment, a length of the second protruding portion 301 of the second transparent cover plate 300 protruding out of the second end 121 of the second surface 120 of the display panel 100 is greater than a length of the first protruding portion 201 of the first transparent cover plate 200 protruding out of the first end 111 of the first surface 110 of the display panel 100, as shown in FIG. 6. In the second embodiment, each second frame 450 is likewise provided with the second positioning mechanism 441, and the second positioning mechanism 441 passes through the corresponding first assembly hole 210 of the first transparent cover plate 200 to be connected to the corresponding first positioning mechanism 421 of the first frame 420, as shown in FIG. 6.

In the second embodiment, the implementations of the first positioning mechanism 421 and the second positioning mechanism 441 are similar to those in the first embodiment. For example, each first positioning mechanism 421 of the first frame 420 and a corresponding second positioning mechanism 441 of the second frame 450 may be respectively implemented as a positioning hole 422 and a positioning pin 442. For example, each first positioning mechanism 421 of the first frame 420 may be implemented as a positioning hole 422, and the corresponding second positioning mechanism 441 of the second frame 450 may be implemented as a positioning pin 442, as shown in FIG. 6. Further, the positioning pin 442 passes through the first assembly hole 210 of the first transparent cover plate 200 and extends to the positioning hole 422.

Similar to the first embodiment, in the second embodiment, each first positioning mechanism 421 of the first frame 420 is implemented to include a first fastening member 424 corresponding to the positioning hole 422, and each first fastening member 424 is fastened through the corresponding positioning hole 422 of the first frame 420 to an end of the corresponding positioning pin 442 of the second frame 450 extending to the positioning hole 422 of the first frame 420. For example, each first fastening member 424 may be implemented as a screw, and the corresponding positioning pin 442 of the second frame 440 may be implemented to have a threaded hole structure corresponding to the screw, so as to fix the first frame 420 and the second frame 440.

In addition, in the second embodiment, the first frame 420 further includes at least one support member 460, and the support member 460 protrudes from the first frame 420 toward the second transparent cover plate 300, e.g., along the direction parallel to the Z-axis in FIG. 6. Further, an end portion of each second frame 450 abuts against the support member 460. A PSA 530 is disposed between the support member 460 and the second transparent cover plate 300 to fix the first frame 420 and the second transparent cover plate 300. The clamping stress on the display panel 100 along the Y-axis direction may be further increased, through the support member 460 of the first frame 420, the PSA 530, and the aforementioned configuration of the second protruding portion 301 of the second transparent cover plate 300.

The second embodiment is different from the first embodiment in that the first transparent cover plate 200 and the first frame 420 at least partially overlap along the direction parallel to the Z-axis, and a length of the overlapping region along the direction parallel to the Y-axis is not less than one-third of a length of the first transparent cover plate 200 along the direction parallel to the Y-axis. In other words, the first transparent cover plate 200 overlaps with the first frame 420 in the direction perpendicular to the first transparent cover plate 200 (Z-axis), and the length of the overlapping region in the direction parallel to the direction of the first protruding portion 201 of the first transparent cover plate 200 protruding out of the first end 111 of the first surface 110 (Y-axis) is not less than one-third of the length of the first transparent cover plate 200 in the same direction (Y-axis). The second embodiment also considers clamping stability of the display panel 100 and maximizes the area of the display panel 100 available for display. Since the second transparent cover plate 300 in the second embodiment does not have second assembly holes, it is preferable that the length of the first protruding portion 201 of the first transparent cover plate 200 protruding out of the display panel 100 is greater than the length in the first embodiment, thus increasing clamping stability of the display panel 100.

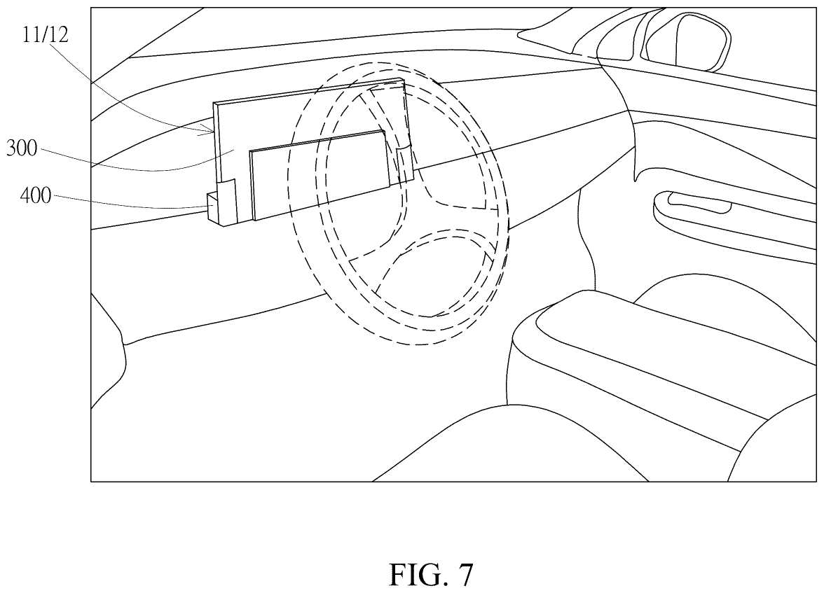

With the aforementioned description, the displays 11 and 12 provided by the embodiments of the present disclosure adopt a fixing method that clamps and fixes the display at only one side thereof, thus facilitating installation in front of the driver as an automotive display. Referring to FIG. 7, which is a schematic view of the display being applied to a vehicle body according to certain embodiments of the present disclosure. The automotive display includes the display panel 100, the first transparent cover plate 200, the second transparent cover plate 300 and the connecting base 400 as described. The display panel 100 has a first surface 110 including a first end 111 and a second surface 120 including a second end 121, where the first surface 110 corresponds to the second surface 120 and the first end 111 corresponds to the second end 121. The first transparent cover plate 200 is connected to the first surface 110 and has a first protruding portion 201 configured to protrude out of the first end 111, and the first protruding portion 201 has at least one first assembly hole 210. The second transparent cover plate 300 is connected to the second surface 120 and has a second protruding portion 301 configured to protrude out of the second end 121. The connecting base 400 is disposed on a vehicle body and includes a first frame 420 and a second frame 440. The first frame 420 is disposed at one side of the first protruding portion 201 and has at least one first positioning mechanism 421. The second frame 440 is disposed at another side of the first protruding portion 201 relative to the first frame 420 and has at least one second positioning mechanism 441. The at least one first positioning mechanism 421 is connected to the at least one second positioning mechanism 441 via one of the at least one first assembly holes 210.

In FIG. 7, the second transparent cover plate 300 of the display is disposed at a side facing the driver. Further, the connecting base 400 of the display is disposed to extend toward a side opposite to the driver, thus reducing space occupation. The specific implementations of the various elements of the automotive display may refer to the display 11 of the first embodiment and the display 12 of the second embodiment as described above, and are thus not further elaborated herein. For simplicity of illustrations in the drawings, other elements are not labeled in FIG. 7.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A display, comprising:
a display panel, having a first surface comprising a first end and a second surface comprising a second end, wherein the first surface corresponds to the second surface, and the first end corresponds to the second end;
a first transparent cover plate, connected to the first surface, wherein the first transparent cover plate has a first protruding portion configured to protrude out of the first end, and the first protruding portion has at least one first assembly hole;
a second transparent cover plate, connected to the second surface, wherein the second transparent cover plate having a second protruding portion configured to protrude out of the second end; and
a connecting base, comprising:
a first frame, disposed at one side of the first protruding portion and having at least one first positioning mechanism; and
a second frame, disposed at another side of the first protruding portion relative to the first frame and having at least one second positioning mechanism, wherein the at least one first positioning mechanism is connected to the at least one second positioning mechanism via one of the at least one first assembly hole.

2. The display of claim 1, wherein the display panel is a transparent display panel.

3. The display of claim 1, wherein the second protruding portion of the second transparent cover plate comprises at least one second assembly hole, the at least one second assembly hole respectively corresponds to the at least one first assembly hole, and the at least one first positioning mechanism is connected to the at least one second positioning mechanism via a corresponding set of the at least one first assembly hole and the at least one second assembly hole.

4. The display of claim 3, wherein the at least one first positioning mechanism and the at least one second positioning mechanism respectively comprise at least one positioning hole and at least one positioning pin, and the at least one positioning pin passes through the at least one first assembly hole and the at least one second assembly hole and extends to the at least one positioning hole.

5. The display of claim 4, wherein the connecting base further comprises a first fastening member, and the first fastening member is fastened to an end of the positioning pin extending to the positioning hole via the positioning hole.

6. The display of claim 1, wherein the first frame is disposed at a side of the first protruding portion opposite to the second protruding portion, and the second frame is disposed between the first protruding portion and the second protruding portion.

7. The display of claim 6, wherein a length of the second protruding portion protruding out of the second end is greater than a length of the first protruding portion protruding out of the first end.

8. The display of claim 6, wherein the connecting base comprises a plurality of second frames, and the second frames are configured to correspond in quantity to the at least one first assembly hole and are arranged at intervals.

9. The display of claim 8, wherein the at least one first positioning mechanism and the at least one second positioning mechanism respectively comprise at least one positioning hole and at least one positioning pin, and the at least one positioning pin passes through the at least one first assembly hole and extends to the at least one positioning hole.

10. The display of claim 9, wherein the connecting base further comprises a second fastening member, and the second fastening member is fastened to an end of the positioning pin extending to the positioning hole via the positioning hole.

11. The display of claim 6, wherein the first frame has at least one support member, the support member protrudes from the first frame toward the second transparent cover plate, and an end portion of each of the second frames respectively abuts against the support member.

12. The display of claim 3, wherein the first transparent cover plate at least partially overlaps with the first frame in a direction perpendicular to the first transparent cover plate, and a length of an overlapping region in a direction parallel to a direction of the first protruding portion protruding out of the first end is not less than one-fourth of a length of the first transparent cover plate in the same direction.

13. The display of claim 6, wherein the first transparent cover plate at least partially overlaps with the first frame in a direction perpendicular to the first transparent cover plate, and a length of an overlapping region in a direction parallel to a direction of the first protruding portion protruding out of the first end is not less than one-third of a length of the first transparent cover plate in the same direction.

14. The display of claim 1, wherein configurations of the at least one first assembly hole comprise:
a distance between the at least one first assembly hole and an edge of the first transparent cover plate being not less than 20 millimeters;
a diameter of the at least one first assembly hole being not less than 1.2 millimeters;
a distance between adjacent first assembly holes being not less than 15 millimeters; or
any combination thereof.

15. The display of claim 1, wherein the first transparent cover plate is a glass cover plate, and the second transparent cover plate is a glass cover plate or a plastic cover plate.

16. The display of claim 15, wherein the Young's modulus of the glass cover plate is between 68,000 MPa and 73,000 MPa and a thickness of the glass cover plate is not less than 2 millimeters, and wherein the Young's modulus of the plastic cover plate is between 2,200 MPa and 3,800 MPa and a thickness of the plastic cover plate is not less than 5 millimeters.

17. The display of claim 1, wherein the Young's modulus of the first transparent cover plate is greater than the Young's modulus of the second transparent cover plate.

18. The display of claim 1, wherein an optical clear adhesive (OCA) is disposed between the display panel and the first transparent cover plate and between the display panel and the second transparent cover plate.

19. The display of claim 1, wherein a pressure-sensitive adhesive (PSA) and rubber are disposed respectively between the first frame and the first transparent cover plate and between the second frame and the second transparent cover plate.

20. The display of claim 11, wherein a pressure-sensitive adhesive is disposed between the support member and the second transparent cover plate.

21. An automotive display, comprising:
a display panel, having a first surface comprising a first end and a second surface comprising a second end, wherein the first surface corresponds to the second surface, and the first end corresponds to the second end;
a first transparent cover plate, connected to the first surface, wherein the first transparent cover plate has a first protruding portion configured to protrude out of the first end, and the first protruding portion has at least one first assembly hole;
a second transparent cover plate, connected to the second surface, wherein the second transparent cover plate having a second protruding portion configured to protrude out of the second end; and
a connecting base, disposed on a vehicle body, and comprising:
a first frame, disposed at one side of the first protruding portion and having at least one first positioning mechanism; and
a second frame, disposed at another side of the first protruding portion relative to the first frame and having at least one second positioning mechanism, wherein the at least one first positioning mechanism is connected to the at least one second positioning mechanism via one of the at least one first assembly hole.
